(19) United States
(12) Patent Application Publication
(10) Pub. No.: US 2021/0238489 A1
(43) Pub. Date: Aug. 5, 2021

(54) SIMPLIFIED FUELS REFINING

(71) Applicant: ExxonMobil Research and Engineering Company, Annandale, NJ (US)

(72) Inventor: Mohsen N. Harandi, New Hope, PA (US)

(21) Appl. No.: 16/776,825

(22) Filed: Jan. 30, 2020

(51) Int. Cl. C10G 63/04; C10G 69/12; B01J 8/26; C10L 1/04; B01J 8/18

(52) U.S. Cl. CPC C10G 63/04; C10G 69/126; B01J 8/26; C10L 1/04; B01J 8/1836; B01J 2208/00513; C10L 2290/06; C10G 2300/1044; C10L 2290/24; C10L 2290/543; C10G 2300/202; C10G 2300/1074

(57) ABSTRACT

Systems and methods are provided for refining crude oils and/or other broad boiling range feedstocks to form fuels. A flash separation can be used to separate the feed into a lower boiling fraction and a higher boiling fraction. After the flash separation, the higher boiling portion is passed into a pyrolysis reactor for conversion of higher boiling compounds and formation of light olefins. The lower boiling fraction can be combined with the resulting pyrolysis effluent as a quench stream. The combined, partially pyrolyzed stream can then be passed into an olefin oligomerization process to convert the olefins formed during pyrolysis into naphtha and/or diesel boiling range compounds. After the olefin oligomerization process, one or more separations can be performed to generate various fractions, including but not limited to a naphtha fraction, a distillate fuel fraction, a fuel oil fraction, a light hydrocarbon recycle stream, and a CO₂-containing stream. Optionally, the naphtha fraction, the distillate fraction, and/or the fuel oil fraction can be hydrotreated.

### FIELD

Systems and methods are provided for refining of crude oil fractions into fuels.

### BACKGROUND

Modern refineries face a variety of challenges. For example, refining can be energy intensive due in part to the number of separate processing units that are conventionally used to perform full conversion of a feedstock into commercial products. From a CO₂ emissions standpoint, many of the processing units within a refinery can represent separate CO₂ sources. As emission requirements continue to be tightened, performing CO₂ capture and/or mitigation for distinct CO₂ sources in a conventional refinery could result in a substantial increase in capital cost and/or operating costs for refiners.

What is needed are systems and methods for performing essentially full upgrading of crudes or crude fractions to commercial products. The systems and methods can provide reduced overall energy consumption and/or can facilitate improved CO₂ management on a refinery scale.

U.S. Pat. No. 3,617,501 describes an integrated process for refining a whole crude.

The entire crude (including naphtha) is initially hydrotreated, followed by separation in an atmospheric distillation tower. The naphtha and distillate portions are used for fuels. The heavier portions are either separated using a vacuum distillation tower or are sent to a hydrocracker for extinction recycle.

U.S. Pat. No. 5,851,381 describes methods of refining crude oil. The various methods include flashing a crude oil to initially separate out a naphtha and lighter portion from the remainder of the crude oil. The remaining portion of the crude is then hydrodesulfurized and/or hydrotreated. At some point, the remaining portion is separated by what is described as an atmospheric distillation tower.

U.S. Pat. No. 4,788,364 describes a method for conversion of paraffins to gasoline. A paraffin-containing feed is dehydrogenated at high temperature in the presence of a first catalyst to form olefins. The olefins are then oligomerized in the presence of a second catalyst to form gasoline.

### SUMMARY

In an aspect, a method is provided for converting a feed into fuels fractions. The method includes performing a flash separation on a feedstock comprising hydrocarbons to form a lower boiling fraction and a higher boiling fraction, the lower boiling fraction comprising 10 wt % or more of the feedstock and a 343° C.− portion, the higher boiling fraction comprising 10 wt % or more of the feedstock and a 538° C.+ portion. The method further includes exposing the higher boiling fraction to fluidized bed pyrolysis conditions in a pyrolysis reactor to form a pyrolysis effluent comprising 20 wt % or more of C₂-C₃ olefins. The method further includes combining at least a portion of the pyrolysis effluent with the lower boiling fraction to form a combined effluent, a temperature of the combined effluent being lower than the pyrolysis effluent by 100° C. or more. The method further includes exposing at least a portion of the combined effluent to a catalyst in an oligomerization zone under fluidized bed olefin oligomerization conditions to form an oligomerized effluent, a combined naphtha boiling range content and distillate boiling range content of the oligomerized effluent being greater than a combined naphtha boiling range content and distillate boiling range content of the combined effluent. Additionally, the method includes separating the oligomerized effluent to form at least a fraction comprising naphtha boiling range components, a fraction comprising distillate boiling range components, and a fraction comprising C₄₋ hydrocarbons, the oligomerized effluent optionally further comprising a fraction comprising vacuum gas oil boiling range components.

In another aspect, a system for upgrading a feedstock is provided. The system includes a flash separator comprising a feed inlet, a light fraction outlet, and a heavy fraction outlet. The system further includes a pyrolysis reaction zone comprising a pyrolysis feed inlet in fluid communication with the heavy fraction outlet, an oxygen-containing gas inlet, and a pyrolysis outlet. The system further includes a quench zone in fluid communication with the pyrolysis outlet and the heavy fraction outlet. Additionally, the system includes an oligomerization zone comprising an oligomerization inlet in fluid communication with the quench zone, and oligomerization outlet.

### BRIEF DESCRIPTION OF THE FIGURES

FIG. 1 shows an example of a refinery configuration.

FIG. 2 shows another example of a refinery configuration.

### DETAILED DESCRIPTION

All numerical values within the detailed description and the claims herein are modified by “about” or “approximately” the indicated value, and take into account experimental error and variations that would be expected by a person having ordinary skill in the art.

In various aspects, systems and methods are provided for refining crude oils and/or other broad boiling range feedstocks to form fuels. Instead of performing an initial distillation, a flash separation can be used to separate the feed into a lower boiling fraction and a higher boiling fraction. Using a flash separation can avoid the higher operating cost and capital equipment that is needed to perform a distillation, such as a separation performed in an atmospheric distillation tower or vacuum distillation tower. After the flash separation, the higher boiling portion is passed into a pyrolysis reactor for conversion of higher boiling compounds and formation of light olefins. This pyrolysis reaction can optionally be performed in the presence of a limited amount of oxygen, so that the heat for the pyrolysis reaction zone can be provided in-situ. The lower boiling fraction can be combined with the resulting pyrolysis effluent as a quench stream. The combined, partially pyrolyzed stream can then be passed into an olefin oligomerization process to convert the olefins formed during pyrolysis into naphtha and/or diesel boiling range compounds. After the olefin oligomerization process, one or more separations can be performed to generate various fractions, including but not limited to a naphtha fraction, a distillate fuel fraction, a fuel oil fraction, a light hydrocarbon recycle stream, and a CO₂-containing stream. Optionally, the naphtha fraction, the distillate fraction, and/or the fuel oil fraction can be hydrotreated.

The above method for processing of a crude oil (or other feedstock) can have a variety of advantages. First, the number of separations is limited. Prior to the final separation to form the various products, the only separation that is needed to be performed is an initial flash separation. This provides the benefit of avoiding the need for an atmospheric distillation and/or vacuum distillation, as would generally be performed in a conventional refinery configuration.

Second, the number of independent sources of CO₂ in the refinery can be reduced. The only combustion of fuels for providing heat corresponds to combustion that occurs in association with the pyrolysis environment, combustion of coke to regenerate the olefin oligomerization catalyst, and any combustion to provide heat for the final hydrotreating steps. For the pyrolysis environment and the regeneration of the olefin oligomerization catalyst, the resulting CO₂ from combustion can remain with the product effluent until the final separation stage. This means that the substantial majority of the CO₂ generated during the refining process is aggregated into a single stream, which can facilitate capture and/or sequester of the CO₂. This ability to retain the CO₂ as part of the process effluent until the final separation stage is enabled in part by unexpected ability to perform the olefin oligomerization in a reaction environment that includes a substantial volume percentage of CO₂.

Third, the above refinery configuration can allow for fuel production based on full conversion of a crude or other feedstock while reducing or minimizing the number of separate processing stages. For example, in addition to an initial distillation stage, a conventional refinery configuration can include a coker for conversion of vacuum resid to naphtha; a fluid catalytic cracking unit for conversion of vacuum gas oil and coker gas oil to naphtha and distillate; a reformer unit to boost the octane of the coker and virgin naphtha; and an alkylation unit for increasing naphtha octane. Instead of this combination of units, each processing different fractions the crude oil, a single process flow of pyrolysis followed by olefin oligomerization can be used to form naphtha, distillate, and fuel oil fractions.

As still a further benefit, the pyrolysis process can also generate hydrogen. This hydrogen can be used to reduce or minimize the amount of hydrogen that is need to perform hydrotreatment on the resulting naphtha, distillate, and fuel oil fractions. Yet another benefit can be reducing or minimizing the amount of fuel gas that is generated. Instead of combusting C₄₋ hydrocarbons (such as C₂-C₄ hydrocarbons) and/or attempting to form a liquefied propane gas product, the C₄₋ hydrocarbons can be recycled to the pyrolysis environment for further production of olefins and conversion to gasoline and distillate.

The configuration can also provide unexpected benefits with regard to the operation of the olefin oligomerization and pyrolysis processes for a fuels production refinery. For example, pyrolysis is conventionally considered a less favorable process for conversion of heavy feed fractions to fuels when compared with coking and/or other lower temperature conversion processes. This is due in part to the increased tendency for benzene formation within the higher temperature pyrolysis environment. Various types of regulations place limits on the amount of benzene that is permitted in gasoline fractions. Thus, the lower benzene production from coking is generally viewed as an advantage for gasoline production. However, the combination of olefin oligomerization with pyrolysis provides a synergistic effect in the form of reducing or minimizing the benzene content in the pyrolysis effluent. Under the olefin oligomerization conditions, the olefins combine with benzene to form various alkylated aromatics. These alkylated aromatics can correspond to either high octane gasoline components, or alternatively can have a sufficiently high molecular weight to be converted into diesel boiling range compounds. In either event, processing the pyrolysis effluent under olefin oligomerization conditions reduces or minimizes one of the expected shortcomings of a pyrolysis process for the purpose of making gasoline and distillate.

In this discussion, reference may be made to the total pyrolysis product and the pyrolysis hydrocarbon product. The total pyrolysis product corresponds to the total fluid phase reaction product from the pyrolysis process. Thus, the total pyrolysis product includes any hydrocarbons formed by cracking during pyrolysis; any combustion products (carbon oxides, water) that are formed if oxygen is included in the reaction environment; any additional products that may be formed (such as H₂S or sulfur oxides, depending on the reaction environment); and any unreacted components (such as nitrogen if air is used as an oxygen source). The pyrolysis hydrocarbon product is defined as the portion of the total pyrolysis product that corresponds to hydrocarbon containing compounds. The pyrolysis hydrocarbon product is defined to include hydrocarbon-like compounds that may contain sulfur or nitrogen as heteroatoms. The pyrolysis hydrocarbon product is defined to not include coke, CO₂, or CO.

In this discussion, unless otherwise specified, “distillate boiling range” refers to an initial or T5 boiling point of 350° F. (177° C.) or more, and/or a final or T95 boiling point of 650° F. (343° C.) or less. In this discussion, unless otherwise specified, “distillate boiling range compounds” refers to one or more compounds that exhibit the distillate boiling range specified above. In this discussion, unless otherwise specified, “naphtha boiling range” refers to an initial or T5 boiling point of 50° F. (10° C.) or more, and/or a final or T95 boiling point of 350° F. (177° C.) or less. In this discussion, unless otherwise specified, “vacuum gas oil boiling range” refers to an initial or T5 boiling point of 650° F. (343° C.) or more, and/or a final or T95 boiling point of 1050° F. (566° C.) or less. In this discussion, unless otherwise specified, “T5 boiling point” refers to a temperature at which 5 wt. % of the feed, effluent, product, stream, or composition of interest will boil. In this discussion, unless otherwise specified, “T95 boiling point” refers to a temperature at which 95 wt % of the feed, effluent, product, stream, or composition of interest will boil.

### Configuration Examples

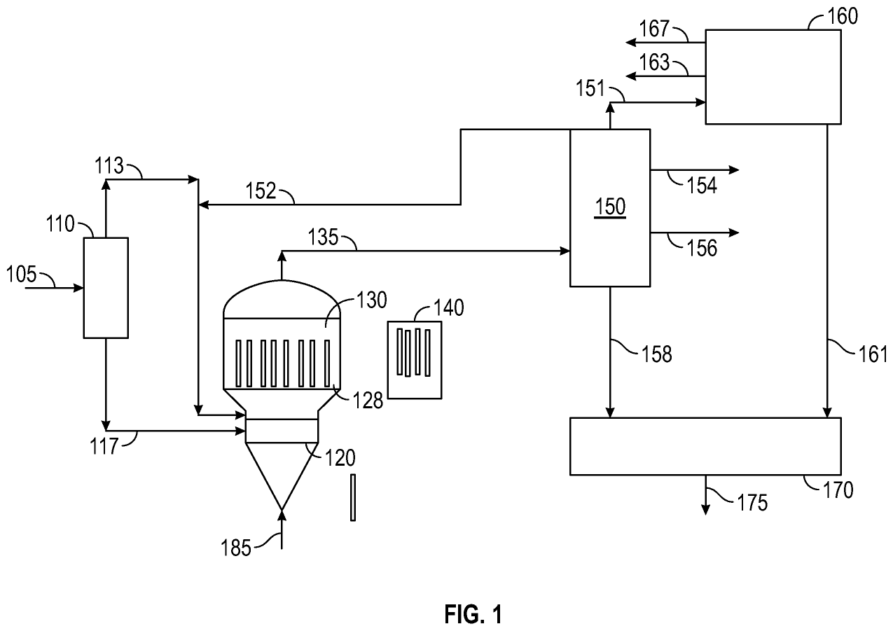

FIG. 1 shows an example of a refinery configuration for processing of a crude oil or other wide boiling range feedstock. In the example configuration shown in FIG. 1, a feedstock 105 is passed into a flash separator 110 to form a lower boiling fraction 113 and a higher boiling fraction 117. The higher boiling fraction can correspond to a resid boiling range fraction, a resid plus vacuum gas oil boiling range fraction, or any other convenient higher boiling portion of the feedstock 105. The lower boiling fraction 113 can correspond to the remainder of feedstock 105. In some alternative aspects, the flash separator 110 can be optional, so that all of feedstock 105 is used in a manner similar to higher boiling fraction 117.

The higher boiling fraction 117 is passed into cracking or pyrolysis reactor 120, where the higher boiling fraction is exposed to high temperature cracking/pyrolysis conditions in an environment including a limited oxygen content. A fluidization and/or oxygen-containing gas flow 185 can also be introduced into the pyrolysis reactor to maintain fluidized bed conditions. In the example shown in FIG. 1, the pyrolysis reactor 120 is integrated with the olefin oligomerization reactor 130, so that the pyrolysis effluent is passed directly into the olefin oligomerization reactor 130. The lower boiling fraction 113 can be added to the pyrolysis effluent to assist with quenching the pyrolysis reaction at or near the location where the pyrolysis effluent enters oligomerization reactor 130. Steam generation tubes 128 can be used to further heat exchange the effluent to reduce the temperature prior to entering oligomerization reactor 130. The quenched pyrolysis effluent is exposed to olefin oligomerization conditions in the presence of a catalyst in the oligomerization reactor 130 to form an oligomerized effluent 135. The oligomerization process results in coke formation on the catalyst, so the catalyst is withdrawn and regenerated in regenerator 140 at a sufficient basis to maintain catalyst activity. As described below, the withdrawal rate of catalyst from the oligomerization process environment for regeneration can be greater than the rate for a conventional oligomerization process.

The oligomerized effluent 135 can then be fractionated 150 to separate out the various types of fuels in the oligomerized effluent. This can result in, for example, production of one or more naphtha fractions 154, one or more distillate fractions 156, and one or more heavy product fractions 158. Additionally, a C₄₋ fraction 152 can be recycled back for combination with the lower boiling fraction 113, so that any olefins in the C₄₋ fraction can be oligomerized while any paraffins can potentially be exposed to sufficiently high temperatures for conversion of at least a portion of the paraffins to olefins. Still another fraction can be an overhead fraction 151.

In the example shown in FIG. 1, overhead fraction 151 can be passed into an additional separation stage 160. The can allow a hydrogen-containing stream 161, a fuel gas stream 163, and a CO₂-containing stream 167 to be separated from the overhead fraction 151. The hydrogen-containing stream can include sufficient hydrogen to be suitable for use as a hydrogen treat gas for a hydrotreating stage, such as hydrotreating stage 170. The fuel gas 163 can include methane, and can potentially be burned as heating fuel for various refinery processes. The CO₂-containing stream 167 can include 50 vol % or more of the CO₂ and/or carbon oxides generated in pyrolysis reactor 120, olefin oligomerization reactor 130, and the associated regenerator 140.

In the example shown in FIG. 1, hydrotreating stage 170 is shown as being used for hydrotreatment of the heavy product fraction 158 to form a low sulfur fuel oil 175. In various aspects, hydrotreating can be performed on one or more of the naphtha fraction 154, distillate fraction 156, and heavy product fraction 158.

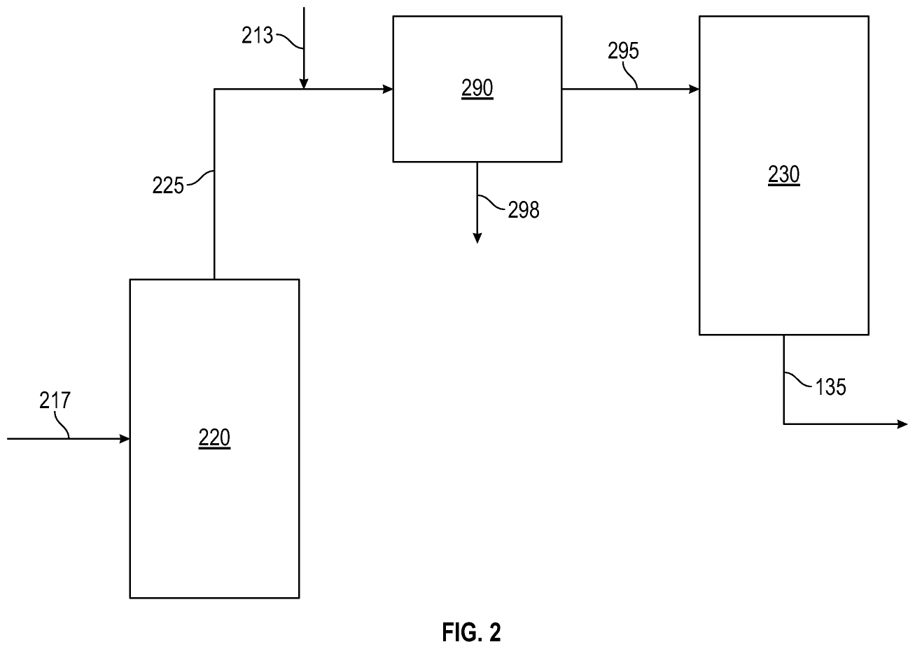

FIG. 2 shows another type of configuration for the combination of a pyrolysis reactor and an olefin oligomerization stage. In FIG. 2, pyrolysis reactor 220 and olefin oligomerization reactor 230 are separate reactor vessels. This can facilitate quenching the pyrolysis effluent and/or separating out portions of the pyrolysis effluent prior to exposing the quenched pyrolysis effluent to the olefin oligomerization conditions. As shown in FIG. 2, a higher boiling fraction 217 can be passed into pyrolysis reactor 220 to form a pyrolysis effluent 225. The pyrolysis effluent 225 can be quenched in part by adding lower boiling fraction 213 as a quench stream. Steam generation or other heat transfer tubes or devices (not shown) can be used to remove the excess heat of reaction from the oligomerization reaction zone. In the example shown in FIG. 2, the pyrolysis effluent can then be separated 290 to separate out a heavy portion 298 of the pyrolysis effluent. For example, heavy portion 298 can include pyrolysis tar and/or vacuum gas oil and/or distillate components of the pyrolysis effluent. The remaining portion 295 of the pyrolysis effluent can then be passed into oligomerization reactor 230.

### Feedstock and Initial Flash Separation

In various aspects, the feedstock for processing corresponds to a crude oil, such as a heavy crude oil, or a blend of one or more crude oils. The crude oil can be derived from any convenient source, including non-conventional sources such as crude oils derived from oil sands, tar sands, or coal. Partial crude oils, where some fraction of the crude oil has already been separated out, can also be used. Optionally, the crude oil and/or one or more intermediate streams formed from the crude oil can be blended with another feed that has already been partially processed at another location.

In some aspects, the feedstock can correspond to a full range feedstock. In such aspects, the T10 distillation point for the feedstock can be 500° F. (260° C.) or less, or 400° F. (204° C.) or less. Additionally or alternately, the T90 distillation point can be 1000° F. (538° C.) or more, or 1050° F. (566° C.) or more. In some aspects, the feedstock can correspond to a heavy oil, where 20 wt % or more of the feedstock corresponds to 566° C.+components, or 30 wt % or more, or 40 wt % or more, such as up to 55 wt % or possibly still higher.

Some crude oils can be relatively high in total acid number (TAN). In one aspect, a crude oil used as a feedstock can have a TAN of at least 0.025, such as at least 0.1, or at least 0.5.

Some crude oils can also have a high metals content, such as a high content of nickel, vanadium, and/or iron. In some aspects, a crude oil used as a feedstock can contain at least 0.00001 grams of Ni/V/Fe (10 ppm), such as at least 0.00005 grams of Ni/V/Fe (50 ppm) or at least 0.0001 grams of Ni/V/Fe (100 ppm) per gram of crude oil, on a total elemental basis of nickel, vanadium and iron.

Contaminants such as nitrogen and sulfur are found in crude oils, often in organically-bound form. Nitrogen content can range from about 50 wppm to about 5000 wppm elemental nitrogen, or about 75 wppm to about 800 wppm elemental nitrogen, or about 100 wppm to about 700 wppm, based on total weight of the heavy hydrocarbon component. The nitrogen containing compounds can be present as basic or non-basic nitrogen species. Examples of basic nitrogen species include quinolines and substituted quinolines. Examples of non-basic nitrogen species include carbazoles and substituted carbazoles.

The sulfur content of a crude oil can range from about 500 wppm to about 100,000 wppm elemental sulfur, or from about 1000 wppm to about 50,000 wppm, or from about 1000 wppm to about 30,000 wppm, based on total weight of the crude oil. Sulfur will usually be present as organically bound sulfur. Examples of such sulfur compounds include the class of heterocyclic sulfur compounds such as thiophenes, tetrahydrothiophenes, benzothiophenes and their higher homologs and analogs. Other organically bound sulfur compounds include aliphatic, naphthenic, and aromatic mercaptans, sulfides, di- and polysulfides.

Crude oils can also contain n-pentane asphaltenes. In an aspect, the crude oil can contain at least about 3 wt % n-pentane asphaltenes, such as at least about 5 wt % or at least about 10 wt % n-pentane asphaltenes.

In some aspects, the feedstock can be split into a lower boiling portion and a higher boiling portion. Depending on the aspect, the higher boiling portion can have various T10 distillation points. If the higher boiling portion corresponds to a resid fraction, the T10 of the higher boiling portion can be 510° C. or more, or 538° C. or more, or 566° C. or more. If the higher boiling portion also includes vacuum gas oil, the T10 of the higher boiling portion can be 325° C. or more, or 350° C. or more, or 400° C. or more. If the higher boiling portion also includes distillate, the T10 of the higher boiling portion can be 250° C. or more. In some aspects, the lower boiling portion can correspond to the balance of the feedstock. Depending on the aspect, the higher boiling portion can correspond to roughly 20 wt % to 80 wt % of the initial feed, or 30 wt % to 70 wt %, or 40 wt % to 60 wt %, or 20 wt % to 50 wt %, or 50 wt % to 80 wt %.

The initial separation can be performed as a flash separation, or another type of separation that can allow separation of a higher boiling fraction from a lower boiling fraction without requiring the reboiler loop that is typically used in a distillation tower. Use of a flash separator as the initial separation stage for processing a crude oil can provide substantial cost savings relative to using an atmospheric distillation tower and/or vacuum distillation tower. Alternatively, the initial separation can be omitted entirely, so that all of the initial feed is passed into the pyrolysis stage.

### Processing Conditions—Pyrolysis

In various aspects, the heavy portion of the feed (or optionally the entire feed) can be exposed to pyrolysis conditions to perform initial feed conversion. An example of suitable pyrolysis conditions can be fluidized bed pyrolysis conditions. The particles in the fluidized bed can correspond to coke particles, heat transfer particles (such as sand), or another convenient type of particle. Using pyrolysis to perform the initial feed conversion can provide advantages and disadvantages. The methods described herein can provide unexpected benefits by reducing or minimizing the disadvantages of using pyrolysis for the initial feed processing.

Pyrolysis is a type of thermal cracking. Thus, pyrolysis can be performed without requiring added hydrogen. This can reduce or minimize the operating costs associated with the pyrolysis process, as a hydrogen plant or other source of hydrogen is not required to perform pyrolysis. The pyrolysis reaction can generate C₂-C₃ olefins as a substantial portion of the conversion product. Depending on the pyrolysis conditions and the feedstock composition, C₂-C₃ olefins (and optionally other C₂-C₃ unsaturated compounds) can correspond to 20 wt % or more of the pyrolysis hydrocarbon product. For example, the C₂-C₃ olefins can correspond to 20 wt % to 50 wt % of the pyrolysis hydrocarbon product, or 20 wt % to 30 wt %. Other hydrocarbon products can include pyrolysis gasoline, pyrolysis distillate, pyrolysis gas oil. The pyrolysis gas oil (343° C.+) plus coke can correspond to 10 wt % to 40 wt % of the total pyrolysis product and/or the pyrolysis gas oil can correspond to 10 wt % to 40 wt % of the pyrolysis hydrocarbon product. The combined pyrolysis gasoline and pyrolysis distillate (C₄—343° C.) can correspond to 10 wt % to 40 wt % of the pyrolysis hydrocarbon product. Due to olefins present in the pyrolysis gasoline and pyrolysis distillate, the total olefin content in the pyrolysis hydrocarbon product can be 30 wt % to 70 wt %. It is noted that 3.0 wt % to 6.0 wt % of the pyrolysis hydrocarbon product can correspond to benzene. In addition to the above pyrolysis hydrocarbon product, coke is also formed.

Using pyrolysis as an initial processing step can pose a variety of related challenges. Some issues can be related to providing sufficient heat for the pyrolysis reaction environment. Pyrolysis is an endothermic reaction that occurs at elevated temperatures. In various aspects, the temperature for the pyrolysis reaction environment can be between 800° C. to 1050° C. Maintaining a pyrolysis reaction environment requires both achieving the desired pyrolysis temperature as well as maintaining the temperature as heat is consumed by the endothermic cracking reactions that occur during pyrolysis. In addition to temperature, other pyrolysis conditions can include a pressure of roughly 100 kPa-a to 1500 kPa-a and a residence time of roughly 1.0 seconds or less, preferably less than 200 milliseconds.

In some aspects, a diluent stream of steam (or another convenient diluent) can also be fed into the pyrolysis reactor to control olefin partial pressure and to improve ethylene and propylene yields. The steam also serves as a fluidizing gas. The weight ratio of steam to feedstock can be between 0.3:1 to 10:1.

One option for providing heat to the pyrolysis reaction environment can be to use heat transfer particles, such as sand, coke, or ceramic particles, to carry heat into the pyrolysis environment. While this can be effective for providing a desired level of heat to the pyrolysis environment, the heat transfer particles requiring heating in a separate vessel. This adds to the cost and complexity of the pyrolysis reaction system.

Another option for providing heat to the pyrolysis reaction environment can be to generate the heat in-situ. This can be achieved, for example, by adding a sub-stoichiometric amount of oxygen into the pyrolysis environment. Adding a sub-stoichiometric amount of oxygen can allow a controlled amount of partial combustion to occur within the reaction environment. The temperature of the environment can be controlled based on the amount of oxygen delivered to the environment. This can allow the crude being processed to serve as the fuel for maintaining the pyrolysis environment, so that the only added reactant is air (or another oxygen source). The amount of oxygen introduced into the reaction environment can be selected based on the amount of pyrolysis performed, so that the heat consumed by the endothermic pyrolysis reaction is balanced by the heat of combustion within the pyrolysis reaction zone. Depending on the aspect, the amount of oxygen introduced into the pyrolysis environment can correspond to sufficient oxygen to combust 3.0 wt % to 40 wt % of the feed to the pyrolysis environment. It is noted that a portion of the carbon that is combusted can correspond to coke that has formed within the pyrolysis environment (such as coke deposited on the fluidized bed particles). The coked particles contain crudes metals as well which enhance combustion reactions on the particles. In addition, the coked particles are heavier and drop more readily to the bottom of the fluid-bed which is richer in oxygen.

Although addition of oxygen to the reaction environment can simplify the pyrolysis reaction system, introduction of oxygen into the pyrolysis reaction environment to generate heat also results in generation of substantial quantities of carbon oxides and water. This can create additional challenges, as carbon oxides cannot be readily separated from C₂-C₄ olefins at elevated temperatures. In order to perform such a separation, refrigeration and compression are typically needed, so that CO₂ can be removed as a solid product. However, providing sufficient separation stages for CO₂ separation from light olefins requires substantial additional equipment footprint, and also leads to increased operating costs. In addition to formation of CO₂, if air is used as the oxygen source, introducing air into the reaction environment can add a substantial amount of nitrogen. The carbon oxides, nitrogen, and water act as diluents in the subsequent olefin oligomerization process. In some aspects, carbon oxides, nitrogen, and water can correspond to major portion of the moles of the total pyrolysis product.

In various aspects, the difficulties associated with both efficient heating of the pyrolysis environment and utilizing the resulting C₂-C₄ olefins can be overcome based on the unexpected synergies between a pyrolysis reactor and an olefin oligomerization process. Instead of attempting to separate carbon oxides from the light olefins, the olefin oligomerization process can be used to oligomerize the olefins and create oligomerized compounds with higher boiling points. The higher boiling oligomerized compounds can then be separated under milder conditions. By operating the oligomerization reaction under conditions that allow for more than 90% conversion of light olefins to oligomerized products, substantially all of the light olefins can be converted. This provides an unexpected improvement in the ability to recover the pyrolysis hydrocarbon product. The oligomerization of the light olefins also reduces the remaining light gas volumes, making it easier to separate the carbon oxides from the remaining C₁-C₄ alkanes. In addition, the oligomerization reaction is exothermic and provides heat to generate steam to be used at the facility.

After pyrolysis, the resulting pyrolysis effluent can be passed into the oligomerization reactor. In some aspects, this can be achieved based on the pyrolysis effluent continuing upward in the reactor to the oligomerization zone. In other aspects, the pyrolysis reaction zone and the oligomerization reaction zone can be located in separate reactors.

Prior to or during the transfer of the pyrolysis effluent to the oligomerization reaction zone, the pyrolysis effluent can undergo one or more modifications. One modification can be to reduce the temperature of the pyrolysis effluent. Generally, pyrolysis occurs at a temperature of 800° C. to 1050° C. In order to reduce or minimize the amount of ongoing pyrolysis reactions, the pyrolysis effluent can be quenched using another liquid stream to form a combined pyrolysis effluent stream. This initial quench can be used to reduce the temperature of the pyrolysis effluent by at least 100° C., so that the temperature is lower than 800° C. One option can be to use the lower boiling portion from the initial flash separation, which can allow additional olefins to be generated from the quench components. Another option can be to use a portion of the bottoms from the fractionator that is used for separating the oligomerized effluent. In this latter option, the bottoms from the fractionator can be introduced into the pyrolysis effluent at a location where some additional pyrolysis of the bottoms can take place. This can allow additional conversion of higher boiling compounds to olefins, thus increasing the yield of naphtha and/or distillate boiling range products. In still other aspects, the quench fluid can correspond to another feedstock that is suitable for cracking.

Another modification can be to separate the pyrolysis effluent to remove a pyrolysis tar portion of the effluent. In addition to olefins and fuels fractions, pyrolysis can also produce coke and pyrolysis tar. In aspects where coke particles are used to form the fluidized bed, the coke can be readily controlled by using oxygen to combust a portion of the coke particles and/or by withdrawing portions of the coke particles. Alternatively, heat transfer particles can be regenerated to remove coke. The pyrolysis tar, however, can potentially cause excessive coking and/or fouling in the oligomerization reaction zone. Separating out a pyrolysis tar fraction can reduce or minimize the fouling in the oligomerization reaction zone. In such an aspect, a portion of vacuum gas oil boiling range material can be separated out with the pyrolysis tar.

After exiting from the pyrolysis reactor and/or the oligomerization reactor, the coke particles and/or heat transfer particles can be separated from the vapor portions of the pyrolyzed effluent using a cyclone or another solid/vapor separator. Such a separator can also remove any other solids present after pyrolysis. Optionally, in addition to a cyclone or other primary solid/vapor separator, one or more filters can be included at a location downstream from the cyclone to allow for removal of fine particles that become entrained in the vapor phase.

### Conditions for Oligomerizing Olefins in an Olefin-Containing Feed

In various aspects, the pyrolysis effluent (or at least a portion thereof) can be exposed to an acidic catalyst (such as a zeolite) under effective conversion conditions for olefinic oligomerization. The olefin oligomerization conditions can allow naphtha and/or distillate boiling range compounds to be formed from the olefins generated during pyrolysis. It is noted that naphtha boiling range or distillate boiling range olefins can also be oligomerized. The olefin oligomerization process can be used to create an oligomerization effluent that has a combined naphtha boiling range content and distillate boiling range content that is greater than the combined naphtha boiling range content and distillate boiling range content of the portion of the pyrolysis effluent that is used as the feed for oligomerization.

Prior to using the pyrolysis effluent as an olefin-containing feed for oligomerization, the pyrolysis effluent can be quenched. For example, the pyrolysis effluent can be quenched by combining the pyrolysis effluent with the lower boiling portion of the initial feed to form a combined effluent. If the entire initial feed is exposed to pyrolysis conditions, then a separate quench stream can be used. After quenching, additional cooling of the combined effluent can be performed in the oligomerization reaction zone to reduce the temperature to the desired oligomerization conditions temperature range of 370° C.-482° C. This additional cooling can be performed, for example, using heat exchange tubes located in the oligomerization zone. Optionally, in aspects where the oligomerization zone is located in a different reactor from the pyrolysis reaction zone, heat exchange and/or addition of quench fluid can be performed in between reactors.

The pyrolysis effluent (or the combined effluent after quenching) represents a non-traditional feed for oligomerization. For example, feeds for olefin oligomerization typically have a substantially narrower boiling range so that about 80 vol % or more of the compounds in the hydrocarbon portion of oligomerization feed correspond to C₄₋ olefins. Additionally, feeds for olefin oligomerization can typically have a relatively low content of carbon oxides. By contrast, a feed based on pyrolysis effluent can include 10 wt % or more of carbon oxides or possibly still higher.

Due in part to the relatively high acetylene content in the pyrolysis effluent, the rate of coke formation on the oligomerization catalyst can be substantially faster than a conventional oligomerization process. Depending on the aspect, the amount of acetylene in the pyrolysis hydrocarbon product can correspond to 1.0 wt % to 3.0 wt % (or even higher) of the C₂ unsaturated hydrocarbons. This acetylene can be quickly converted to coke under the oligomerization conditions. In order to maintain activity for oligomerization, it is desirable to regenerate the oligomerization catalyst at a sufficient rate so that the average weight of coke on the catalyst is less than 10 wt %, or less than 4 wt %, relative to the weight of the catalyst particles. Under conventional conditions, the average residence time in the reactor for the catalyst can be fairly long. However, due to the additional components that are present in a pyrolysis effluent, the average rate of coke formation results in a substantially higher catalyst circulation rate than the conventional oligomerization process.

Due to this higher average rate of coke formation, the residence time of the oligomerization catalyst in the reactor can be reduced, so that the catalyst is regenerated more frequently. In some aspects, the average residence time for the oligomerization catalyst in the oligomerization reactor can be an order of magnitude shorter than the conventional oligomerization reaction.

The oligomerization process can also be performed at a relatively low total pressure and/or a relatively low olefin partial pressure. For example, the olefin partial pressure can be 130 kPa-a or less, or 100 kPa-a or less, or 70 kPa-a or less, such as down to 40 kPa-a or possibly still lower. The relatively low olefin partial pressure can be due in part to a relatively low total pressure in the oligomerization environment. The total pressure for oligomerization can be 150 kPa-a or more, or 200 kPa-a or more, or 250 kPa-a or more, or 300 kPa-a or more, such as up to 500 kPa-a or possibly still higher.

A zeolite is an example of a suitable acidic catalyst. Optionally, the zeolite or other acidic catalyst can also include a hydrogenation functionality, such as a Group VIII metal or other suitable metal that can activate hydrogenation/dehydrogenation reactions. The olefin-containing feed can be exposed to the acidic catalyst without providing substantial additional hydrogen to the reaction environment. Added hydrogen refers to hydrogen introduced as an input flow to the process, as opposed to any hydrogen that might be generated in-situ during processing. Exposing the feed to an acidic catalyst without providing substantial added hydrogen is defined herein as exposing the feed to the catalyst in the presence of a) less than about 100 SCF/bbl (about 17 m³/m³) of added hydrogen, or less than about 50 SCF/bbl (about 10 m³/m³); b) a partial pressure of less than about 50 psia (350 kPa) of hydrogen, or less than about 15 psia (100 kPa); or c) a combination thereof. It is noted that the definition of added H₂ excludes any H₂ entering the oligomerization reactor which is produced in-situ in the pyrolysis reactor.

The acidic catalyst used in the processes described herein can be any alumina-containing catalyst, such as a zeolite-based catalyst. For example, the acidic catalyst can comprise an acidic zeolite in combination with a binder or matrix material such as alumina, silica, or silica-alumina, and optionally further in combination with a hydrogenation metal. More generally, the acidic catalyst can correspond to a molecular sieve (such as a zeolite) in combination with a binder, and optionally a hydrogenation metal. Molecular sieves for use in the catalysts can be medium pore size zeolites, such as those having the framework structure of ZSM-5, ZSM-11, ZSM-12, ZSM-22, ZSM-23, ZSM-35, ZSM-48, or MCM-22. Such molecular sieves can have a 10-member ring as the largest ring size in the framework structure. The medium pore size zeolites are a well-recognized class of zeolites and can be characterized as having a Constraint Index of 1 to 12. Constraint Index is determined as described in U.S. Pat. No. 4,016,218 incorporated herein by reference. Catalysts of this type are described in U.S. Pat. Nos. 4,827,069 and 4,992,067 which are incorporated herein by reference and to which reference is made for further details of such catalysts, zeolites and binder or matrix materials.

Additionally or alternately, catalysts based on large pore size framework structures (12-member rings) such as the synthetic faujasites, especially zeolite Y, such as in the form of zeolite USY. Zeolite beta may also be used as the zeolite component. Other materials of acidic functionality which may be used in the catalyst include the materials identified as MCM-36 and MCM-49. Still other materials can include other types of molecular sieves having suitable framework structures, such as silicoaluminophosphates (SAPOs), aluminosilicates having other heteroatoms in the framework structure, such as Ga, Sn, or Zn, or silicoaluminophosphates having other heteroatoms in the framework structure. Mordenite or other solid acid catalysts can also be used as the catalyst.

The pyrolysis effluent/combined effluent can be exposed to the acidic catalyst under fluidized bed conditions. In some aspects, the particle size of the catalyst can be selected in accordance with the fluidization regime which is used in the process. Particle size distribution can be important for maintaining turbulent fluid bed conditions as described in U.S. Pat. No. 4,827,069 and incorporated herein by reference. Suitable particle sizes and distributions for operation of dense fluid bed and transport bed reaction zones are described in U.S. Pat. Nos. 4,827,069 and 4,992,607 both incorporated herein by reference. Particle sizes in both cases will normally be in the range of 10 to 300 microns, typically from 20 to 100 microns.

Acidic zeolite catalysts suitable for use as described herein can be those exhibiting high hydrogen transfer activity and having a zeolite structure of ZSM-5, ZSM-11, ZSM-12, ZSM-22, ZSM-23, ZSM-35, ZSM-48, MCM-22, MCM-36, MCM-49, zeolite Y, and zeolite beta. Such catalysts can be capable of oligomerizing olefins from the olefin-containing feed. For example, such catalysts can convert C₂-C₄ olefins, such as those present in a refinery fuel gas, to C₅+ olefins. Such catalysts can also be capable of converting organic sulfur compounds such as mercaptans to hydrogen sulfide without added hydrogen by utilizing hydrogen present in the hydrocarbon feed. Group VIII metals such as nickel may be used as desulfurization promoters. A fluid-bed reactor/regenerator can assist with maintaining catalyst activity in comparison with a fixed-bed system. Further, the hydrogen sulfide produced in accordance with the processes described herein can be removed using conventional amine based absorption processes.

ZSM-5 crystalline structure is readily recognized by its X-ray diffraction pattern, which is described in U.S. Pat. No. 3,702,866. ZSM-11 is disclosed in U.S. Pat. No. 3,709,979, ZSM-12 is disclosed in U.S. Pat. No. 3,832,449, ZSM-22 is disclosed in U.S. Pat. No. 4,810,357, ZSM-23 is disclosed in U.S. Pat. Nos. 4,076,842 and 4,104,151, ZSM-35 is disclosed in U.S. Pat. No. 4,016,245, ZSM-48 is disclosed in U.S. Pat. No. 4,375,573 and MCM-22 is disclosed in U.S. Pat. No. 4,954,325. The U.S. Patents identified in this paragraph are incorporated herein by reference.

While suitable zeolites having a coordinated metal oxide to silica molar ratio of 20:1 to 200:1 or higher may be used, it can be advantageous to employ aluminosilicate ZSM-5 having a silica:alumina molar ratio of about 25:1 to 70:1, suitably modified. A typical zeolite catalyst component having Bronsted acid sites can comprises, consist essentially of, or consist of crystalline aluminosilicate having the structure of ZSM-5 zeolite with 5 to 95 wt. % silica, clay and/or alumina binder.

These siliceous zeolites can be employed in their acid forms, ion-exchanged or impregnated with one or more suitable metals, such as Ga, Pd, Zn, Ni, Co, Mo, P, and/or other metals of Periodic Groups III to VIII. The zeolite may include other components, generally one or more metals of group IB, IIB, IIIB, VA, VIA or VIIIA of the Periodic Table (IUPAC).

Useful hydrogenation components can include the noble metals of Group VIIIA, such as platinum, but other noble metals, such as palladium, gold, silver, rhenium or rhodium, may also be used. Base metal hydrogenation components may also be used, such as nickel, cobalt, molybdenum, tungsten, copper or zinc.

The catalyst materials may include two or more catalytic components which components may be present in admixture or combined in a unitary multifunctional solid particle.

In addition to the preferred aluminosilicates, the gallosilicate, ferrosilicate and “silicalite” materials may be employed. ZSM-5 zeolites can be useful in the process because of their regenerability, long life and stability under the extreme conditions of operation. Usually the zeolite crystals have a crystal size from about 0.01 to over 2 microns or more, such as 0.02-1 micron.

In some aspects, the fluidized bed catalyst particles can contain about 25 wt. % to about 40 wt.% H-ZSM-5 zeolite, based on total catalyst weight, contained within a silica-alumina matrix. Typical Alpha values for the catalyst can be about 100 or less.

The Alpha Test is described in U.S. Pat. 3,354,078, and in the Journal of Catalysis, Vol. 4, p. 527 (1965); Vol. 6, p. 278 (1966); and Vol. 61, p. 395 (1980), each incorporated herein by reference as to that description.

In various aspects, the olefin-containing feed may be exposed to the acidic catalyst by using a moving or fluid catalyst bed reactor. In such aspects, the catalyst may be regenerated, such via continuous oxidative regeneration. The extent of coke loading on the catalyst can then be continuously controlled by varying the severity and/or the frequency of regeneration. In a turbulent fluidized catalyst bed the conversion reactions are conducted in a vertical reactor column by passing hot reactant vapor upwardly through the reaction zone and/or reaction vessel at a velocity greater than dense bed transition velocity and less than transport velocity for the average catalyst particle. A continuous process is operated by withdrawing a portion of coked catalyst from the reaction zone and/or reaction vessel, oxidatively regenerating the withdrawn catalyst and returning regenerated catalyst to the reaction zone at a rate to control catalyst activity and reaction severity to effect feedstock conversion. Preferred fluid bed reactor systems are described in Avidan et al U.S. Pat. No. 4,547,616; Harandi & Owen U.S. Pat. No. 4,751,338; and in Tabak et al U.S. Pat. No. 4,579,999, incorporated herein by reference. In other aspects, other types of reactors can be used, such as fixed bed reactors, riser reactors, fluid bed reactors, and/or moving bed reactors.

In one or more aspects, the effective conversion conditions for exposing the olefin-containing feed to an acidic catalyst can include a temperature of 700° F. (˜370° C.) to 900° F. (482° C.); a pressure of 15 psia (˜100 kPa-a) to 105 psia (˜700 kPa-a); and a weight hourly space velocity of 0.05 hr⁻¹ to 20 hr⁻¹, or 0.05 to 10 hr⁻¹, or 0.1 to 10 hr⁻¹, or 0.1 to 2 hr⁻¹, or 0.1 hr⁻¹ to 1.0 hr⁻¹, or 0.1 hr⁻ to 0.75 hr⁻¹, or 0.1 hr⁻¹ to 0.6 hr⁻¹.

Operating the olefin-oligomerization at higher temperatures, such as 371° C. to 482° C., can provide various advantages when using pyrolysis effluent as the olefin-containing feed. First, the higher temperatures can be beneficial for increasing olefin conversion, so that 95 wt % or more of the olefins are oligomerized, or 98 wt % or more. Second, the higher temperatures can tend to cause naphtha formed by oligomerization to have a higher research octane number (RON). In some aspects, the naphtha formed by oligomerization can have a RON of 85 or more, or 90 or more, or 93 or more, such as up to 102 or possibly still higher.

Another potential advantage of the olefin oligomerization process can be a reduction of the benzene formed during pyrolysis. Under the oligomerization conditions, olefins can alkylate benzene formed during pyrolysis to generate alkylated benzene compounds. Such compounds are preferred for naphtha fractions used as gasoline.

### Separation of Oligomerized Product

The oligomerized product can be separated in a plurality of stages. First a fractionation stage can be used to separate liquid products (naphtha, distillate, vacuum gas oil) from the various gas phase products. The gas phase products can then be further separated in a series of stages. The gas phase products can include CO₂ and CO (generated by oxidation in the pyrolysis environment), N₂ (if air is used as the source of oxygen), C₁-C₄ alkanes, H₂O, and H₂ formed during the oligomerization process. Optionally, prior to separating the gas phase products, the gas phase products can be exposed to a water gas shift catalyst to convert CO and H₂O to H₂ and CO₂.

For the gas phase products, based on the oligomerization of substantially all olefins (95% wt % or more relative to the weight of the olefins) in the pyrolysis effluent, the oligomerized product can include 2 vol % or less of C₂-C₄ olefins, or 1 vol % or less. Thus, the volume of gas that needs to be processed is substantially reduced.

The separation of the gas phase products can be performed in any convenient manner For example, after performing the optional water gas shift reaction, the gas phase products can be cooled to condense out water. Further cooling and compression can then be used to separate out the CO₂. Prior to or after removing the water and CO₂, at least a portion of the H₂ can be separated from the gas phase products by, for example, membrane separation. The C₂-C₄ paraffins can be separated out using typical separation stages for light gas separation. The methane, N₂, and any H₂ remaining in the gas phase products can then be used as a fuel gas.

In various aspects, one of the advantages of using a combination of pyrolysis and oligomerization for processing of a crude oil is that substantially all of the CO₂ generated during the process can be included as part of the effluent. In addition to reducing the number of distinct streams requiring processing for CO₂ capture, the concentration of CO₂ in the resulting gas phase products is also higher after performing oligomerization and subsequently removing the oligomerized product. In aspects where the heat for pyrolysis is provided by adding oxygen to the pyrolysis reaction environment, the CO₂ concentration in the gas phase products can be 15 wt % or more. Depending on the conditions during oligomerization, the pressure of the gas phase products can also be greater than 100 kPa-a. An amine wash is an example of a suitable method for separating CO₂ from the gas phase products, but other convenient methods can also be used, such as cryogenic separation or extraction with a solvent.

### Optional Hydrotreatments of the Product Effluent

Optionally, at least a portion of the oligomerization effluent can be treated in one or more hydroproces sing stages to improve properties of the product effluent. Depending on the aspect, the naphtha fraction, the distillate fraction, and/or the heavy (vacuum gas oil) fraction can be exposed to a hydrotreating catalyst under hydrotreating conditions.

The reaction conditions for hydroprocessing can include an LHSV of 0.3 to 5.0 hr⁻¹, a total pressure from about 200 psig (1.4 MPag) to about 3000 psig (20.7 MPa), a treat gas containing at least about 80% hydrogen (remainder inert gas), and a temperature of from about 500° F. (260° C.) to about 800° F. (427° C.). Preferably, the reaction conditions include an LHSV of from about 0.5 to about 1.5 hr⁻¹, a total pressure from about 700 psig (4.8 MPa) to about 2000 psig (13.8 MPa), and a temperature of from about 600° F. (316° C.) to about 700° F. (399° C.). The treat gas rate can be from about 500 SCF/B (84 Nm³/m³) to about 10000 SCF/B (1685 Nm³/m³) of hydrogen, depending on various factors including the nature of the feed being hydrotreated. Note that the above treat gas rates refer to the rate of hydrogen flow. If hydrogen is delivered as part of a gas stream having less than 100% hydrogen, the treat gas rate for the overall gas stream can be proportionally higher.

In some aspects, the hydroprocessing can reduce the sulfur content of the product effluent to a suitable level. For the naphtha fraction and/or the distillate fraction, the sulfur content can be reduced sufficiently so that the product effluent can have 500 wppm sulfur or less, or 250 wppm or less, or 100 wppm or less, or 50 wppm or less. Additionally or alternately, the sulfur content of the product effluent can be at least 1 wppm sulfur, or at least 5 wppm, or at least 10 wppm. The heavy fraction (vacuum gas oil and/or vacuum resid) can be hydrotreated to reduce the sulfur content to 100 wppm to 5000 wppm.

The catalyst in a hydroprocessing treatment for reducing sulfur content can be a conventional hydrotreating catalyst, such as a catalyst composed of a Group VIB metal (Group 6 of IUPAC periodic table) and/or a Group VIII metal (Groups 8-10 of IUPAC periodic table) on a support. Suitable metals include cobalt, nickel, molybdenum, tungsten, or combinations thereof. Preferred combinations of metals include nickel and molybdenum or nickel, cobalt, and molybdenum. Suitable supports include silica, silica-alumina, alumina, and titania.

### Additional Embodiments

Embodiment 1. A method for converting a feed into fuels fractions, comprising: performing a flash separation on a feedstock comprising hydrocarbons to form a lower boiling fraction and a higher boiling fraction, the lower boiling fraction comprising 10 wt % or more of the feedstock and a 343° C.− portion, the higher boiling fraction comprising 10 wt % or more of the feedstock and a 538° C.+ portion; exposing the higher boiling fraction to fluidized bed pyrolysis conditions in a pyrolysis reactor to form a pyrolysis effluent comprising 20 wt % or more of C₂-C₃ olefins; combining at least a portion of the pyrolysis effluent with the lower boiling fraction to form a combined effluent, a temperature of the combined effluent being lower than the pyrolysis effluent by 100° C. or more; exposing at least a portion of the combined effluent to a catalyst in an oligomerization zone under fluidized bed olefin oligomerization conditions to form an oligomerized effluent, a combined naphtha boiling range content and distillate boiling range content of the oligomerized effluent being greater than a combined naphtha boiling range content and distillate boiling range content of the combined effluent; and separating the oligomerized effluent to form at least a fraction comprising naphtha boiling range components, a fraction comprising distillate boiling range components, and a fraction comprising C₄₋ hydrocarbons, the oligomerized effluent optionally further comprisng a fraction comprising vacuum gas oil boiling range components.

Embodiment 2. The method of Embodiment 1, the method further comprising exposing at least a portion of the vacuum gas oil boiling range components to a hydroprocessing catalyst in the presence of hydrogen under hydroprocessing conditions to form a hydroprocessed effluent, the hydroprocessed effluent comprising a lower sulfur content than the fraction comprising the vacuum gas oil boiling range portion.

Embodiment 3. The method of any of the above embodiments, wherein exposing the higher boiling fraction to fluidized bed pyrolysis conditions comprises exposing the higher boiling fraction to fluidized bed pyrolysis conditions in the presence of oxygen.

Embodiment 4. The method of Embodiment 3, wherein the pyrolysis effluent comprises 10 wt % or more of carbon oxides, or wherein the pyrolysis hydrocarbon product comprises 30 wt % to 70 wt % olefins, or a combination thereof.

Embodiment 5. The method of any of the above embodiments, wherein the higher boiling fraction is exposed to the pyrolysis conditions in the presence of heat transfer particles, the method further comprising: withdrawing a portion of the heat transfer particles from the pyrolysis reactor, the withdrawn portion of the heat transfer particles comprising coke; exposing the withdrawn portion of the heat transfer particles to an oxygen-containing gas in a regenerator under combustion conditions to form heated heat transfer particles; and returning at least a portion of the heated heat transfer particles to the pyrolysis reactor, the heat transfer particles optionally comprising coke particles, sand, ceramic heat transfer particles, or a combination thereof.

Embodiment 6. The method of any of the above embodiments, wherein separating the oligomerized effluent further comprises forming a hydrogen-containing fraction, the at least a portion of the fraction comprising the vacuum gas oil boiling range portion being exposed to the hydroprocessing catalyst in the presence of at least a portion of the hydrogen-containing fraction.

Embodiment 7. The method of any of the above embodiments, further comprising exposing at least a portion of the fraction comprising the C₄₋ hydrocarbons to the pyrolysis conditions.

Embodiment 8. The method of any of the above embodiments, wherein the at least a portion of the combined effluent comprises 10 vol % to 20 vol % olefins, or wherein the naphtha boiling range components have a research octane number of 85 or more, or a combination thereof.

Embodiment 9. The method of any of the above embodiments, wherein the oligomerization conditions comprise a total pressure of 200 kPa-a to 700 kPa-a, or wherein the oligomerization conditions comprise an olefin partial pressure of 100 kPa-a or less, or a combination thereof.

Embodiment 10. The method of any of the above embodiments, wherein separating the oligomerized effluent to form at least a fraction comprising naphtha boiling range components, a fraction comprising distillate boiling range components, and a fraction comprising C₄₋ hydrocarbons comprises: separating the fraction comprising the C₄₋ hydrocarbons from the fraction comprising naphtha boiling range components, the fraction comprising the C₄₋ hydrocarbons comprising 15 wt % or more of CO, CO₂, or a combination thereof; and separating the fraction comprising the C₄₋ hydrocarbons to form a stream comprising a majority of the CO₂ and a stream comprising a majority of the C₄₋ hydrocarbons, relative to a content of CO₂ and C₄₋ hydrocarbons in the fraction comprising the C₄₋ hydrocarbons.

Embodiment 11. The method of Embodiment 10, further comprising exposing the fraction comprising the C₄₋ hydrocarbons to water gas shift reaction conditions prior to separating the fraction comprising the C₄₋ hydrocarbons to form the stream comprising a majority of the CO₂ and the stream comprising a majority of the C₄₋ hydrocarbons.

Embodiment 12. A system for upgrading a feedstock, comprising: a flash separator comprising a feed inlet, a light fraction outlet, and a heavy fraction outlet; a pyrolysis reaction zone comprising a pyrolysis feed inlet in fluid communication with the heavy fraction outlet, an oxygen-containing gas inlet, and a pyrolysis outlet; a quench zone in fluid communication with the pyrolysis outlet and the heavy fraction outlet; and an oligomerization zone comprising an oligomerization inlet in fluid communication with the quench zone, and oligomerization outlet.

Embodiment 13. The system of Embodiment 12, further comprising one or more separation stages in fluid communication with the oligomerization outlet.

Embodiment 14. The system of Embodiment 13, wherein the one or more separation stages further comprise a water gas shift reaction stage, or wherein the system further comprises a hydrotreating stage in fluid communication with at least one of the one or more separation stages, or a combination thereof.

Embodiment 15. The system of any of Embodiments 12-14, wherein the pyrolysis reaction zone, the quench zone, and the oligomerization zone are contained within a single reactor vessel.

Additional Embodiment A. The method of any of Embodiments 1-11, wherein the fraction comprising naphtha boiling range components further comprises distillate boiling range components, or wherein the fraction comprising vacuum gas oil boiling range components further comprises distillate boiling range components, or a combination thereof.

Additional Embodiment B. An oligomerized effluent formed according to the method of any of Embodiments 1-11 or using the system of any of Embodiments 12-15.

Although the present invention has been described in terms of specific embodiments, it is not so limited. Suitable alterations/modifications for operation under specific conditions should be apparent to those skilled in the art. It is therefore intended that the following claims be interpreted as covering all such alterations/modifications as fall within the true spirit/scope of the invention.

1. A method for converting a feed into fuels fractions, comprising:
performing a flash separation on a feedstock comprising hydrocarbons to form a lower boiling fraction and a higher boiling fraction, the lower boiling fraction comprising 10 wt % or more of the feedstock and a 343° C.− portion, the higher boiling fraction comprising 10 wt % or more of the feedstock and a 538° C.+ portion;
exposing the higher boiling fraction to fluidized bed pyrolysis conditions in a pyrolysis reactor to form a pyrolysis effluent comprising 20 wt % or more of C₂-C₃ olefins;
combining at least a portion of the pyrolysis effluent with the lower boiling fraction to form a combined effluent, a temperature of the combined effluent being lower than the pyrolysis effluent by 100° C. or more;
exposing at least a portion of the combined effluent to a catalyst in an oligomerization zone under fluidized bed olefin oligomerization conditions to form an oligomerized effluent, a combined naphtha boiling range content and distillate boiling range content of the oligomerized effluent being greater than a combined naphtha boiling range content and distillate boiling range content of the combined effluent; and
separating the oligomerized effluent to form at least a fraction comprising naphtha boiling range components, a fraction comprising distillate boiling range components, and a fraction comprising C₄₋ hydrocarbons.

2. The method of claim 1, wherein the oligomerized effluent further comprises a fraction comprising vacuum gas oil boiling range components.

3. (canceled)

4. The method of claim 1, wherein exposing the higher boiling fraction to fluidized bed pyrolysis conditions comprises exposing the higher boiling fraction to fluidized bed pyrolysis conditions in the presence of oxygen.

5. (canceled)

6. The method of claim 1, wherein the higher boiling fraction is exposed to the pyrolysis conditions in the presence of heat transfer particles, the method further comprising:
withdrawing a portion of the heat transfer particles from the pyrolysis reactor, the withdrawn portion of the heat transfer particles comprising coke;
exposing the withdrawn portion of the heat transfer particles to an oxygen-containing gas in a regenerator under combustion conditions to form heated heat transfer particles; and
returning at least a portion of the heated heat transfer particles to the pyrolysis reactor.

7. The method of claim 6, wherein the heat transfer particles comprise coke particles, sand, ceramic heat transfer particles, or a combination thereof.

8. (canceled)

9. The method of claim 1, further comprising exposing at least a portion of the fraction comprising the C₄₋ hydrocarbons to the pyrolysis conditions.

10. The method of claim 1, wherein the at least a portion of the combined effluent comprises 10 vol % to 20 vol % olefins.

11. The method of claim 1, wherein the oligomerization conditions comprise a total pressure of 200 kPa-a to 700 kPa-a, or wherein the oligomerization conditions comprise an olefin partial pressure of 100 kPa-a or less, or a combination thereof.

12. The method of claim 1, wherein the naphtha boiling range components have a research octane number of 85 or more.

13. The method of claim 1, wherein separating the oligomerized effluent to form at least a fraction comprising naphtha boiling range components, a fraction comprising distillate boiling range components, and a fraction comprising C₄₋ hydrocarbons comprises:
separating the fraction comprising the C₄₋ hydrocarbons from the fraction comprising naphtha boiling range components, the fraction comprising the C₄₋ hydrocarbons comprising 15 wt % or more of CO, CO₂, or a combination thereof; and
separating the fraction comprising the C₄₋ hydrocarbons to form a stream comprising a majority of the CO₂ and a stream comprising a majority of the C₄₋ hydrocarbons, relative to a content of CO₂ and C₄₋ hydrocarbons in the fraction comprising the C₄₋ hydrocarbons.

14. The method of claim 13, further comprising exposing the fraction comprising the C₄₋ hydrocarbons to water gas shift reaction conditions prior to separating the fraction comprising the C₄₋ hydrocarbons to form the stream comprising a majority of the CO₂ and the stream comprising a majority of the C₄₋ hydrocarbons.

15-20. (canceled)
